(19) United States
(12) Patent Application Publication
(10) Pub. No.: US 2002/0147088 A1
(43) Pub. Date: Oct. 10, 2002

(54) Container blank

(76) Inventor: Christopher M. Edwards, Midland, MI (US)

Correspondence Address: Gary C. Cohn PLLC, Suite 105, 4010 Lake Washington Blvd., NE, Kirkland, WA, 98033, US

(21) Appl. No.: 09/827,662

(22) Filed: Apr. 6, 2001

(51) Int. Cl. B31B 1/25

(52) U.S. Cl. 493/80

(57) ABSTRACT

A container blank comprises a scored sheet material. The score lines divide the sheet into center, side and corner panels. The corner panels are further scored, so that the blank can be folded into a box or similar container that has no seams.

### BACKGROUND OF THE INVENTION

This invention relates to containers and methods for making them.

Boxes and other containers are often made of folded sheet materials. The sheet materials are usually shipped in a flat form in order to minimize volume. The sheet materials are often scored or creased along fold lines. When making the container, the sheet is folded along the fold lines to bring the sheet into the desired shape.

Previous folded containers have a seam where edges of the sheet materials come together or overlap. Although these seams can be glued together, the seams represent places where the container can leak. This limits the uses of many containers, or else requires that careful precautions be used to prevent leakage. These precautions can add significantly to the cost of the container.

It would be desirable to have a method for folding a sheet material to make a container that does not have seams, and would thus be suitable for packaging wet or liquid materials.

### SUMMARY OF THE INVENTION

In one aspect, this invention is a container blank comprised of a rectangular or square sheet material having a plurality of score lines such that the sheet material is foldable at the score lines to form a container, wherein

a) a side panel score line runs substantially parallel to each outside edge of the sheet material at a distance L from the corresponding outside edge;

b) each side panel score line intersects two other side panel score lines to divide the sheet material into

1. a center square or rectangular panel enclosed by the side panel score lines and residing in a center portion of the blank;

2. side panels along each side of the blank, exterior to a side panel score line and between adjacent corner panels, each side panel having a width L, and

3. four square corner panels, each residing at a corner of the sheet material and having first and second exterior sides, each of length L, that meet at an exterior corner of corner panel, and first and second interior sides, that (1) are each of length L, (2) meet at an interior corner of the corner panel, (3) are adjacent to the first and second exterior sides, respectively, and (4) are formed by segments of intersecting side panel score lines;

c) each corner panel has a corner score line running from said interior corner to said exterior corner and forming an angle with the first interior side and an angle with the second interior side;

d) each corner panel has a first intermediate score line that runs from said interior corner to the first exterior side and approximately bisects the angle formed by the corner score line and the first interior side, and a second intermediate score line that runs from said interior corner to the second exterior side and approximately bisects the angle formed by the corner score line and the second interior side; and

e) each corner panel has a flap score line that connects the point where the first intermediate score line meets the first exterior side to the point where the second intermediate score line meets the second exterior side.

The blank is easily folded into a container (or box lid) that has no seams. As seams have the potential for leaking, the absence of seams in a container made from the blank makes the container particularly useful for packaging “wet” goods. Because the blank is made from a flat sheet, it can be packed flat and thus take up minimal volume for shipping. The blank is easily assembled into a container as described below. As the blank is square or rectangular, there are no scrap and off-cuts in producing them.

In a second aspect, this invention is a method of making a container, comprising

a) folding a rectangular or square sheet material along side panel score lines that run substantially parallel to each outside edge of the sheet material at a distance L from the corresponding outside edge and which divide the sheet material into

1. a center panel enclosed by the side panel score lines and residing in a center portion of the sheet material;

2. side panels along each side of the sheet material, exterior to said first fold lines and between adjacent corner panels, each side panel having a width L, and

3. four square corner panels, each residing at a corner of the sheet material and having first and second exterior sides, each of length L, that meet at an exterior corner of corner panel, and first and second interior sides, that (1) are each of length L, (2) meet at an interior corner of the corner panel, (3) are adjacent to the first and second exterior sides, respectively, and (4) are formed by segments of intersecting side panel score lines,

b) folding each corner panel along a corner fold line that runs from said interior corner to said exterior corner and forms an angle with the first interior side and an angle with the second interior side;

c) folding each corner panel along a first intermediate score line that runs from said interior corner to the first exterior side and approximately bisects the angle formed by the corner score line and the first interior side, and a second intermediate score line that runs from said interior corner to the second exterior side and approximately bisects the angle formed by the corner score line and the second interior side;

wherein steps b and c are conducted such that the first and second interior sides of each corner panel are brought together and meet, the corner panel is folded around an outside portion of two adjacent side panels, and a flap portion of the corner panel extends above the adjacent side panels, and

d) folding said flap portion of the corner panel downward and inside of the adjacent side panels.

In third aspect, this invention is a method of making a container, comprising

a) folding a rectangular or square sheet material along side panel score lines that run substantially parallel to each outside edge of the sheet material at a distance L from the corresponding outside edge and which divide the sheet material into

1. a center panel enclosed by the side panel score lines and residing in a center portion of the sheet material;

2. side panels along each side of the sheet material, exterior to said first fold lines and between adjacent corner panels, each side panel having a width L, and

3. four square corner panels, each residing at a corner of the sheet material and having first and second exterior sides, each of length L, that meet at an exterior corner of corner panel, and first and second interior sides, that (1) are each of length L, (2) meet at an interior corner of the corner panel, (3) are adjacent to the first and second exterior sides, respectively, and (4) are formed by segments of intersecting side panel score lines,

b) folding each corner panel along a corner fold line that runs from said interior corner to said exterior corner and forms an angle with the first interior side and an angle with the second interior side;

c) folding each corner panel along a first intermediate score line that runs from said interior corner to the first exterior side and approximately bisects the angle formed by the corner score line and the first interior side, and a second intermediate score line that runs from said interior corner to the second interior side and approximately bisects the angle formed by the corner score line and the second interior side

wherein steps b and c are conducted such that the first and second interior sides of each corner panel are brought together and meet, each corner panel is folded inside a portion of two adjacent side panels, and a flap portion of each corner panel extends above the adjacent side panels, and

d) folding said flap portion of each corner panel downward and outside of the adjacent side panels.

### BRIEF DESCRIPTION OF THE DRAWINGS

FIG. 1 is an overhead view of an embodiment of the container blank of the invention.

FIGS. 2A, 2B and 2C illustrate a method of folding a corner of a container blank of the invention to form a container.

FIG. 3 illustrates an embodiment of a container made in accordance with the invention.

FIGS. 4A, 4B and 4C illustrate a second method of folding a corner of a container blank of the invention to form a container.

FIG. 5 illustrates a second embodiment of a container made in accordance with the invention.

### DETAILED DESCRIPTION OF THE INVENTION

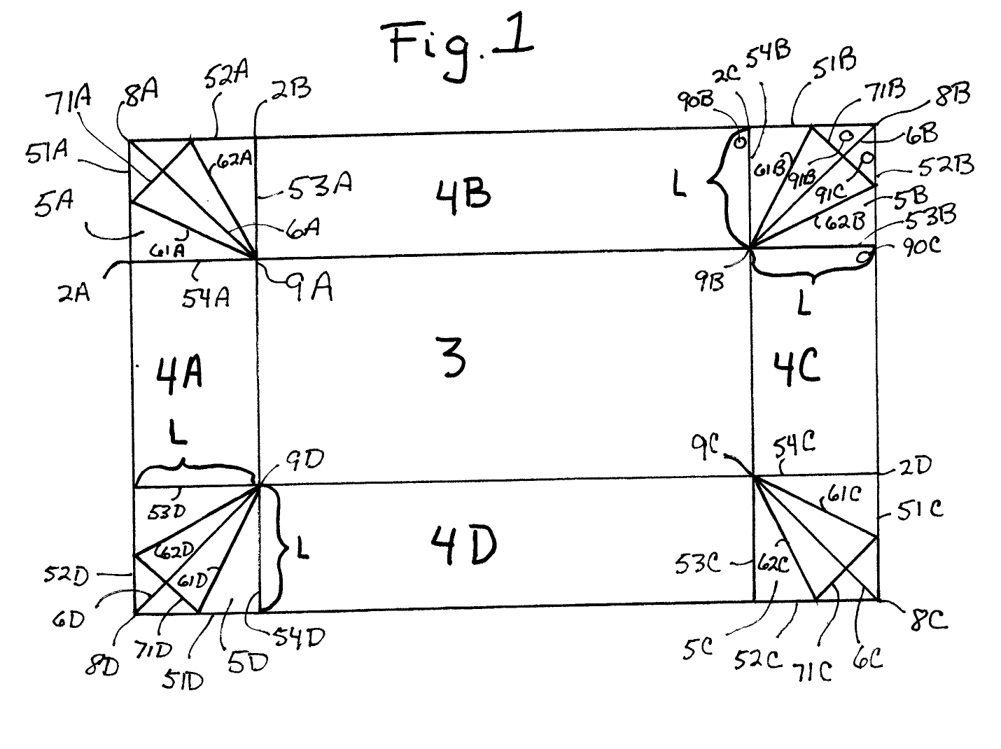

A blank of the invention is shown in FIG. 1. In FIG. 1, blank 1 has side panel score lines 2A, 2B, 2C and 2D, each of which runs parallel to a side of the blank at a distance L. The side panel score lines divide the blank into 9 panels. Center panel 3 is enclosed by side panel score lines 2A, 2B, 2C and 2D, and occupies the center of the blank. Corner panels 5A, 5B, 5C and 5D occupy the corners of the blank. Side panels 4A, 4B, 4C and 4D are along the sides of the blank, between the adjacent corner panels.

Each corner panel has an interior corner (9A, 9B, 9C, and 9D, respectively), formed by the intersection of two side panel score lines. Corner panels 5A, 5B, 5C and 5D each have exterior corners (8A, 8B, 8C and 8D, respectively). Corner panels 5A, 5B, 5C and 5D also have exterior sides 51A, 52A, 51B, 52B, 51C, 52C, 51D and 52D.

Each corner panel has a corner score line that runs from the interior corner to the exterior corner. Thus, for corner panel 5A, corner score line 6A runs from interior corner 9A to exterior corner 8A. Similarly, corner panel 5B has corner score line 6B that runs from interior corner 9B to exterior corner 8B, corner panel 5C has corner score line 6C that runs from interior corner 9C to exterior corner 8C, and corner panel 5D has corner score line 6D that runs from interior corner 9D to exterior corner 8D.

Each corner panel also has two intermediate score lines. These intermediate score lines each approximately bisect the angle formed by the corner score line and in interior side of the corner panel. Thus, corner panel 5A has intermediate score line 61A that runs from interior corner 9A to of exterior side 51A and approximately bisects the angle formed by corner score line 6A and interior side 54A. Corner panel 5A also has intermediate score line 62A that runs form interior corner 9A to exterior side 52A and approximately bisects the angle formed by corner score line 6A and interior side 53A. The corresponding intermediate score lines for the remaining corners are designated as 61B and 62B (for corner 5B), 61C and 63C (for corner 5C) and 61D and 62D (for corner 5D).

In addition, each corner panel has a flap score line. The flap score line connects the points where in intermediate score lines meet the exterior sides of the corner panel. In FIG. 1, these are indicated by reference numerals 71A, 71B, 71C and 71D for corner panels 5A, 5B, 5C and 5D, respectively.

The blank is made from any type of sheet material that can be scored to form fold lines. Thus, the blank can be paper, cardboard, waxed paper, metal foil or sheet, any type of plastic that is capable of having a crease “coined” into it, laminated sheet materials of various types, and the like. Corrugated materials such as corrugated cardboard or twin wall plastic sheets may also be used, and are preferred for larger containers. Suitable plastics include polypropylene, polyethylene, nylon, and the like. A preferred plastic is polypropylene because score lines in polypropylene tend to be extremely fatigue resistant. This helps prevent tears and holes from opening when folded, and thus make for a particularly useful container for wet goods. Good fatigue resistance also favors re-use of the container.

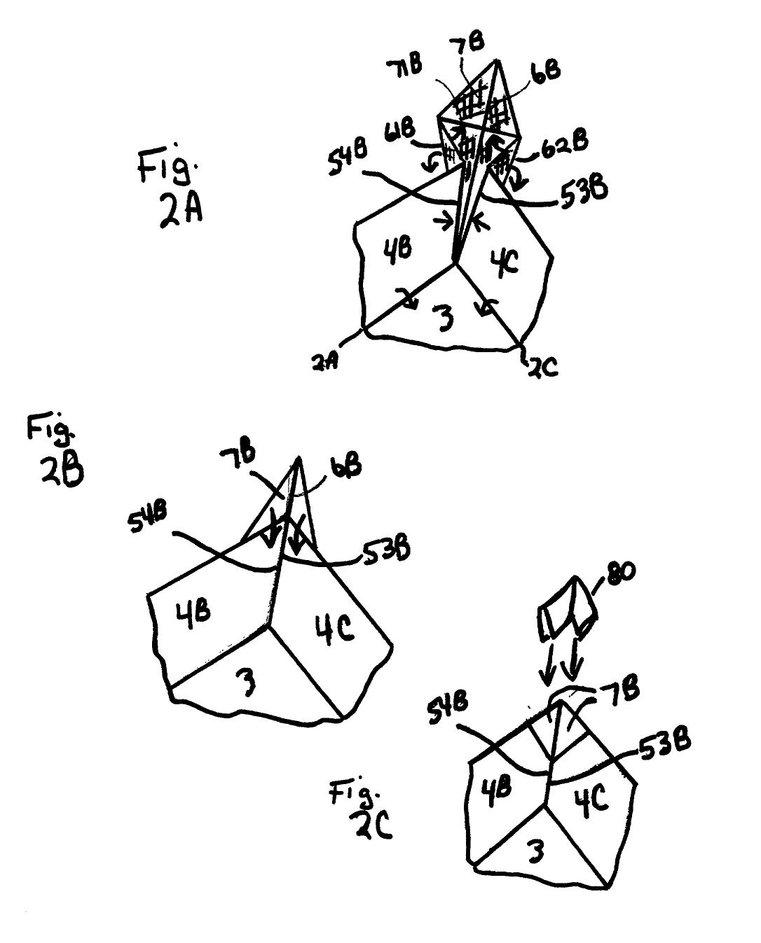

One method of folding the blank into a container is illustrated in FIGS. 2A, 2B and 2C. In FIG. 2A, adjacent side panels 4B and 4C are folded upward along side panel score lines 2A and 2C. This brings together interior sides 53B and 54B of corner 5B. Corner 5B is folded along intermediate score lines 61B and 62B and along corner score line 6B. Intermediate score lines 61B and 62B are pulled forward and into contact with side panels 4B and 4C, respectively, to bring corner panel into the position shown in FIG. 2B. In this position, flap score line 71B is aligned with the top edges of side panels 4B and 4C, and flap portion 7B of corner panel 5B protrudes above side panels 4B and 4C. To complete the corner, flap portion 7B is folded along flap score line 71B down inside the corner, to the position shown in FIG. 2C.

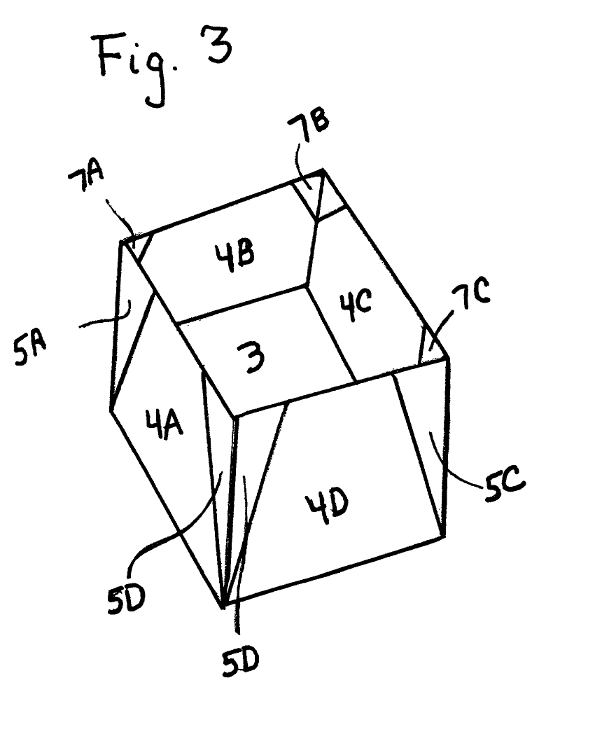

This process is repeated for all four corners to make the completed container. The completed container is illustrated in FIG. 3.

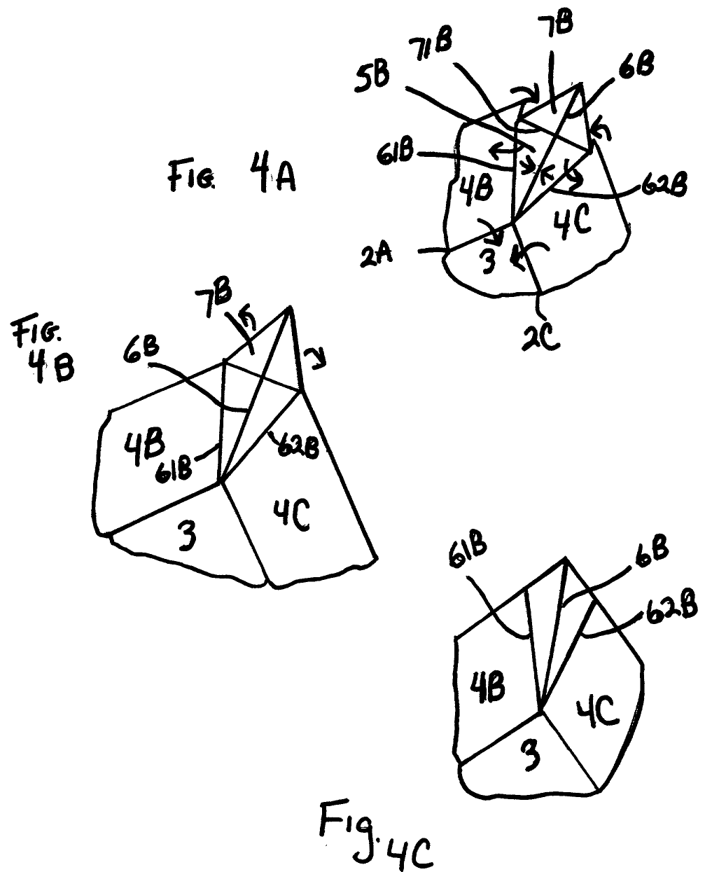

A second method of folding the blank into a container is illustrated in FIGS. 4A, 4B and 4C. In FIG. 4A, adjacent side panels 4B and 4C are folded upward along side panel score lines 2A and 2C. This brings together interior sides 53B and 54B of corner 5B as before, although in this method 5B is folded inwardly rather than outwardly. Corner 5B is folded downwardly along intermediate score lines 61B and 62B and upwardly along corner score line 6B. Intermediate score lines 61B and 62B are pushed down into contact with side panels 4B and 4C, respectively, and corner score line 6B is pushed into the newly formed corner to bring corner panel 5B into the position shown in FIG. 4B. In this position, flap score line 71B is aligned with the top edges of side panels 4B and 4C and flap portion 7B of corner panel 5B protrudes above side panels 4B and 4C. To complete the corner, flap portion 7B is folded along flap score line 71B down and outside the corner, as shown in FIG. 4C.

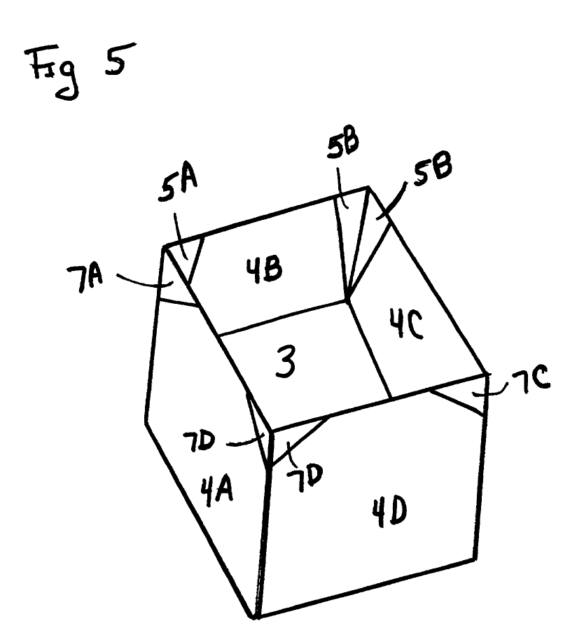

As before, this process is repeated for all four corners to make the completed container. The completed container is illustrated in FIG. 5.

As will be apparent from the foregoing, folds will be made upwardly from certain of the score lines and downwardly from others. It is often easier to fold the blank toward the side on which it is scored. Thus, it is possible and even preferred to put score lines on each side of the blank, so that when the container is assembled, each fold is made toward the side on which the corresponding score line has been made. However, all score lines may be made on the same side of the blank, if desired. Yet another alternative is to place all score lines on both sides of the blank, so as to most easily accommodate either of the folding methods described above.

In many cases, the completed corners are self-supporting, in that they are mechanically held in place due to the folds in the corner panels. However, it may be desirable to supplement the corners in some cases. This can be achieved in a number of ways. For example, an adhesive such as a contact adhesive can be applied to adhere the corner panel into folded position. Suitable areas for applying such an adhesive are shown as shaded areas in FIG. 2A. A rigid clip, such as clip 80 in FIG. 2C, can be pressed over the folded corner to supplement its strength. Similarly, rivets, staples, nails and a wide variety of other types of fasteners can be used to hold the corner panels in folded position. If desired, press-studs can be formed into the sheet material, as shown in corner panel 5B in FIG. 1. Side panels 4b and 4C, respectively, have indentations or holes 90B and 90C, that are adapted to received raised areas 91B and 91C, respectively, on corner panel 5B. When the sheet is folded into a container, raised area 91B is pressed into indentation or hole 90B to form a mechanical fastening. Raised area 91C is pressed into hole 90C in the same manner.

The container blank is easily made by forming a continuous strip of the sheet material, and mechanically forming the score lines. Perforations or heavier score lines can be used to separate individual blanks, so they can be separated by tearing. Making the blanks as a continuous strip in this way allows them to be shipped as a roll (for more flexible materials) or folded as a stacked concertina. Both perforation and scoring techniques are well known. The particular methods of performing these steps are not critical.

Depending of course on the materials of construction, the containers are useful for food packaging (such as for wet foods such as ice cream, pate, yogurt, dressings, meats, and the like), liquid and drink storage, as liners for other containers, and other types of boxes. The blanks can be used to form lids as well.

What is claimed is:

1. A container blank comprised of a rectangular or square sheet material having a plurality of score lines such that the sheet material is foldable at the score lines to form a container, wherein
a) a side panel score line runs substantially parallel to each outside edge of the sheet material at a distance L from the corresponding outside edge;
b) each side panel score line intersects two other side panel score lines to divide the sheet material into
1. a center square or rectangular panel enclosed by the side panel score lines and residing in a center portion of the blank;
2. side panels along each side of the blank, exterior to a side panel score line and between adjacent corner panels, each side panel having a width L, and
3. four square corner panels, each residing at a corner of the sheet material and having first and second exterior sides, each of length L, that meet at an exterior corner of corner panel, and first and second interior sides, that (1) are each of length L, (2) meet at an interior corner of the corner panel, (3) are adjacent to the first and second exterior sides, respectively, and (4) are formed by segments of intersecting side panel score lines;
c) each corner panel has a corner score line running from said interior corner to said exterior corner and forming an angle with the first interior side and an angle with the second interior side;
d) each corner panel has a first intermediate score line that runs from said interior corner to the first exterior side and approximately bisects the angle formed by the corner score line and the first interior side, and a second intermediate score line that runs from said interior corner to the second exterior side and approximately bisects the angle formed by the corner score line and the second interior side; and
e) each corner panel has a flap score line that connects the point where the first intermediate score line meets the first exterior side to the point where the second intermediate score line meets the second exterior side.

2. The container blank of claim 1 in the form of a continuous strip of multiple container blanks wherein the individual container blanks are separated by perforations or score lines.

3. The container blank of claim 1 wherein the sheet material is paper, cardboard, waxed paper, metal foil or sheet, a plastic that is capable of having a crease “coined” into it, or a laminated sheet material.

4. The container blank of claim 1 wherein the sheet material is cardboard or a twin wall plastic sheet.

5. The container blank of claim 1 wherein the sheet material is polypropylene.

6. The container blank of claim 2 having areas of an adhesive for holding the container in a folded condition.

7. A method of making a container, comprising
a) folding a rectangular or square sheet material along side panel score lines that run substantially parallel to each outside edge of the sheet material at a distance L from the corresponding outside edge and which divide the sheet material into
1. a center panel enclosed by the side panel score lines and residing in a center portion of the sheet material;
2. side panels along each side of the sheet material, exterior to said first fold lines and between adjacent corner panels, each side panel having a width L, and
3. four square corner panels, each residing at a corner of the sheet material and having first and second exterior sides, each of length L, that meet at an exterior corner of corner panel, and first and second interior sides, that (1) are each of length L, (2) meet at an interior corner of the corner panel, (3) are adjacent to the first and second exterior sides, respectively, and (4) are formed by segments of intersecting side panel score lines,
b) folding each corner panel along a corner fold line that runs from said interior corner to said exterior corner and forms an angle with the first interior side and an angle with the second interior side;
c) folding each corner panel along a first intermediate score line that runs from said interior corner to the first exterior side and approximately bisects the angle formed by the corner score line and the first interior side, and a second intermediate score line that runs from said interior corner to the second exterior side and approximately bisects the angle formed by the corner score line and the second interior side;
wherein steps b and c are conducted such that the first and second interior sides of each corner panel are brought together and meet, the corner panel is folded around an outside portion of two adjacent side panels, and a flap portion of the corner panel extends above the adjacent side panels, and
d) folding said flap portion of the corner panel downward and inside of the adjacent side panels.

8. A method of making a container, comprising
a) folding a rectangular or square sheet material along side panel score lines that run substantially parallel to each outside edge of the sheet material at a distance L from the corresponding outside edge and which divide the sheet material into
1. a center panel enclosed by the side panel score lines and residing in a center portion of the sheet material;
2. side panels along each side of the sheet material, exterior to said first fold lines and between adjacent corner panels, each side panel having a width L, and
3. four square corner panels, each residing at a corner of the sheet material and having first and second exterior sides, each of length L, that meet at an exterior corner of corner panel, and first and second interior sides, that (1) are each of length L, (2) meet at an interior corner of the corner panel, (3) are adjacent to the first and second exterior sides, respectively, and (4) are formed by segments of intersecting side panel score lines,
b) folding each corner panel along a corner fold line that runs from said interior corner to said exterior corner and forms an angle with the first interior side and an angle with the second interior side;
c) folding each corner panel along a first intermediate score line that runs from said interior corner to the first exterior side and approximately bisects the angle formed by the corner score line and the first interior side, and a second intermediate score line that runs from said interior corner to the second interior side and approximately bisects the angle formed by the corner score line and the second interior side
wherein steps b and c are conducted such that the first and second interior sides of each corner panel are brought together and meet, each corner panel is folded inside a portion of two adjacent side panels, and a flap portion of each corner panel extends above the adjacent side panels, and
d) folding said flap portion of each corner panel downward and outside of the adjacent side panels.
